(19) United States
(12) Patent Application Publication
(10) Pub. No.: US 2022/0104264 A1
(43) Pub. Date: Mar. 31, 2022

(54) CONFIGURATION METHOD AND TERMINAL DEVICE

(71) Applicant: VIVO MOBILE COMMUNICATION CO.,LTD., Guangdong (CN)

(72) Inventor: Yumin WU, Guangdong (CN)

(21) Appl. No.: 17/547,295

(22) Filed: Dec. 10, 2021

Related U.S. Application Data
(63) Continuation of application No. PCT/CN2020/097796, filed on Jun. 23, 2020.

(30) Foreign Application Priority Data
Jun. 28, 2019 (CN) 201910578751.4

(51) Int. Cl. H04W 74/08; H04W 76/19

(52) U.S. Cl. CPC H04W 74/0825; H04W 76/19; H04W 74/0866; H04W 74/0816

(57) ABSTRACT

A configuration method and a terminal device are provided. The method includes: performing a first target operation on a target object based on target configuration information, where in a case that the target configuration information is configuration information for uplink congestion failure detection, the target object is used for uplink congestion failure detection; and/or in a case that the target configuration information is configuration information for uplink congestion failure recovery, the target object is used for uplink congestion failure recovery. The method is applied to a scenario in which the terminal device transmits an uplink signal.

### CROSS-REFERENCE TO RELATED APPLICATIONS

This application is a continuation application of PCT International Application No. PCT/CN2020/097796 filed on Jun. 23, 2020, which claims priority to Chinese Patent Application No. 201910578751.4, filed with the China National Intellectual Property Administration on Jun. 28, 2019 and entitled “CONFIGURATION METHOD AND TERMINAL DEVICE”, the disclosures of which are incorporated herein by reference in their entireties.

### TECHNICAL FIELD

Embodiments of this disclosure relate to the field of communications technologies, and in particular, to a configuration method and a terminal device.

### BACKGROUND

In 5G communications systems, before transmitting an uplink signal in an unlicensed band, a transmit end (for example, user equipment (UE)) needs to perform listen before talk (LBT) in the unlicensed band. If it is detected that the band is not occupied, that is, it is detected that the band is in an idle state, the transmit end may transmit signals. On the contrary, if it is detected that the band is being occupied, the transmit end cannot transmit signals.

In the related art, when the UE detects that the band is occupied, the uplink transmission fails. After the number of uplink transmission failures that the UE has experienced in this band reaches a predetermined number of times, the UE can further determine that an uplink congestion failure has occurred. In addition, before the UE determines an uplink congestion failure, a network device may configure a corresponding uplink congestion failure detection configuration (for example, the above-mentioned predetermined number of times) for the UE.

However, no efficient processing solutions exist after the terminal device has received the configuration information.

### SUMMARY

Embodiments of this disclosure provide a configuration method and a terminal device.

According to a first aspect, an embodiment of this disclosure provides a configuration method, applied to a terminal device, where the method includes performing a first target operation on a target object based on target configuration information, where in a case that the target configuration information is configuration information for uplink congestion failure detection, the target object is used for uplink congestion failure detection; and/or in a case that the target configuration information is configuration information for uplink congestion failure recovery, the target object is used for uplink congestion failure recovery.

According to a second aspect, an embodiment of this disclosure provides a terminal device, including an execution module, where the execution module is configured to perform a first target operation on a target object based on target configuration information, where in a case that the target configuration information is configuration information for uplink congestion failure detection, the target object is used for uplink congestion failure detection; and/or in a case that the target configuration information is configuration information for uplink congestion failure recovery, the target object is used for uplink congestion failure recovery.

According to a third aspect, an embodiment of this disclosure provides a terminal device, including a processor, a memory, and a computer program stored in the memory and capable of running on the processor, where when the computer program is executed by the processor, the steps of the configuration method according to the first aspect are implemented.

According to a fourth aspect, an embodiment of this disclosure provides a computer-readable storage medium, where the computer-readable storage medium stores a computer program, and when the computer program is executed by a processor, the steps of the configuration method according to the first aspect are implemented.

### BRIEF DESCRIPTION OF DRAWINGS

FIG. 1 is a possible schematic structural diagram of a communications system in an embodiment of this disclosure;

FIG. 2 is a first schematic flowchart of a configuration method according to an embodiment of this disclosure;

FIG. 3 is a second schematic flowchart of a configuration method according to an embodiment of this disclosure;

FIG. 4 is a third schematic flowchart of a configuration method according to an embodiment of this disclosure;

FIG. 5 is a fourth schematic flowchart of a configuration method according to an embodiment of this disclosure;

FIG. 6 is a first schematic structural diagram of a terminal device according to an embodiment of this disclosure; and

FIG. 7 is a second schematic structural diagram of a terminal device according to an embodiment of this disclosure.

### DETAILED DESCRIPTION

The following clearly describes the technical solutions in the embodiments of this disclosure with reference to the accompanying drawings in the embodiments of this disclosure. Apparently, the described embodiments are some but not all of the embodiments of this disclosure. All other embodiments obtained by a person of ordinary skill in the art based on the embodiments of this application shall fall within the protection scope of this application.

It should be noted that “I” in this specification represents or, for example, A/B may represent A or B; and that the term “and/or” in this specification describes only an association relationship for describing associated objects and represents that three relationships may exist, for example, A and/or B may represent the following three cases: A alone, both A and B, and B alone.

It should be noted that for ease of clear description of the technical solutions of the embodiments of this application, in the embodiments of this application, terms “first,” “second”, and the like are used to distinguish the same items or similar items having substantially the same functions or roles, and those skilled in the art can understand that the words “first,” “second”, and the like do not constitute any limitation on a quantity and an execution order. For example, a first target operation and a second target operation are used to distinguish different operations, rather than describe a specific sequence of operations.

It should be noted that, in the embodiments of this disclosure, terms such as “exemplary” or “for example” are used to represent an example, an instance, or an illustration. Any embodiment or design solution described as “an example” or “for example” in the embodiments of this disclosure should not be construed as being preferred or advantageous over other embodiments or design solutions. To be precise, the terms such as “example” or “for example” are intended to present a related concept in a specific manner.

It should be noted that “of”, “corresponding or relevant”, and “corresponding” in the embodiments of this application may be interchangeably used sometimes. It should be noted that expressed meanings are consistent when differences are not emphasized. “A plurality of” in the embodiments of this application means at least two.

For ease of understanding, the following describes some of the terms involved in the embodiments of this disclosure.

1. New Radio Unlicensed (New RAT Un-licensed, NR-U) System

In NR-U systems of 5G communications systems, an unlicensed band is used to transmit and receive data, and a signal transmit end needs to comply with rules for use of the unlicensed band. For an unlicensed band, before transmitting a signal, a transmit end needs to monitor whether the band is occupied (or idle), and the transmit end can transmit the signal if the band is not occupied (or idle). If the band is occupied, the transmit end cannot transmit the signal, meaning that listen before talk (LBT) has failed. The transmit end may be a terminal device (for example, user equipment (UE)) or a network device. A terminal device is taken as an example of a transmit end for description in the embodiments of this disclosure.

Specifically, in a scenario in which the terminal device is to transmit an uplink signal, the terminal device may detect whether an uplink transmission failure (for example, an uplink signal transmission failure) has occurred, and detect whether an uplink congestion failure has occurred. For example, for an LBT failure, the terminal device may detect whether an uplink transmission failure has occurred, and whether an uplink congestion failure has occurred. That the terminal device experienced an uplink congestion failure means that a count of uplink transmission failures that the terminal device has experienced within a specified period of time reaches or exceeds a threshold (for example, a threshold configured by a network device).

Further, after the terminal device detects the uplink congestion failure, a procedure can be triggered to perform uplink congestion failure recovery, to allow the terminal device to successfully transmit uplink signals. When the terminal device is performing the uplink congestion failure recovery, if a count of uplink congestion failures within a specified period of time reaches a threshold (for example, a threshold configured by the network device), it indicates that the uplink congestion failure recovery has failed; and if within a specified period of time, no uplink congestion failure has occurred, or a count of uplink congestion failures does not reach the threshold, it indicates that the uplink congestion failure recovery is successful.

It should be noted that in a scenario in which a connection between the terminal device and the network device has been established, the network device can configure configuration information for uplink congestion failure detection for the terminal device, for example, configuration information for a timer and/or a counter for uplink congestion failure detection, to support the terminal device to perform uplink congestion failure detection based on the configuration information. For example, when the terminal device performs uplink congestion failure detection, if within a timing time of the timer, a count of uplink failures that the terminal device has experienced reaches or exceeds a count threshold of the counter, it is determined that an uplink congestion failure has occurred currently.

Similarly, in a scenario in which a connection between the terminal device and the network device has been established, the network device can configure configuration information for uplink congestion failure recovery for the terminal device, for example, configuration information for a timer and/or a counter for uplink congestion failure recovery, to support the terminal device in performing the uplink congestion failure recovery procedure based on the configuration information.

2. Bandwidth Part (BWP)

In 5G communications systems, a terminal device (for example, UE) may only support a relatively small operating bandwidth (for example, 5 megahertz

(MHz)), while a cell on a network side can support a relatively large bandwidth (for example, 100 MHz). The small bandwidth part, on which the UE operates, of the large bandwidth is referred to as a BWP. From a perspective of UE configuration, for different UE functions, a BWP can be a BWP of one cell. A plurality of different BWPs use a same hybrid automatic repeat request (HARQ) entity.

Specifically, the network side (for example, a network device) may configure one or more BWPs for the UE, and may switch a currently activated BWP of the UE by using a BWP switching command (for example, physical downlink control channel (PDCCH) indication information), that is, activating a new BWP and deactivating the currently activated BWP. Currently, the UE can activate only one BWP for one cell. BWP switching is a switching between a plurality of BWPs of a same cell.

In addition, the network side can configure a BWP inactivity timer (BWP-InactivityTimer) for an activated BWP. Further, in a case that the timer is started after the UE activates a BWP, the UE may switch, after the timer expires, the activated BWP to a default BWP (that is, default BWP) configured on the network side.

Additionally, the UE can autonomously switch a BWP in the following two cases:

(1) The UE triggers a random access procedure on the currently operating BWP, but no random access resource is available on the currently operating BWP, so the UE switches to an initial BWP (that is, initial BWP), and initiates the random access procedure on the initial BWP.

(2) A UE connection failure occurs on the currently operating BWP, so the UE switches to another BWP.

The UE connection failure includes the following cases:

a. Handover failure. For example, BWP handover is not completed within a specified time (for example, timer t304 expiry);

b. Secondary cell group change (SCG change) failure. For example, an access by the UE to a new secondary cell group (SCG) is not completed within a specified time (for example, timer t307 expiry);

c. Radio link failure (RLF); and

d. Uplink congestion failure, that is, listen before talk failures (LBT failure) continuously occur in uplink transmission of the UE.

The “radio link failure” includes at least one of the following:

(1) a physical layer out of synchronization (for example, timer t310 expiry);

(2) a media access control (Media Access Control, MAC) layer random access failure, for example, the random access failure reaches a maximum number of random access attempts;

(3) an indication indicating that the maximum number of retransmissions at RLC layer is reached, for example, the maximum number of RLC layer retransmissions is reached; or

(4) a beam failure, for example, beam recovery procedure failure.

3. Dual Connectivity (DC)

When the UE operates in a DC mode, the UE may be configured with two cell groups, namely, a master cell group (MCG) and an SCG. The MCG includes at least a primary cell (PCell), and may additionally include one or more secondary cells (SCell). The SCG includes at least a primary secondary cell (PSCell), and may additionally include one or more SCells.

The configuration method provided in the embodiments of this disclosure may be applied to scenarios such as uplink congestion failure detection and/or uplink congestion failure recovery, and a specific usage scenario is not limited in the embodiments of this disclosure. Specifically, the configuration method may be applied to a process in which the network device configures (or reconfigures) configuration information for uplink congestion failure detection and/or configuration information for uplink congestion failure recovery for the terminal device.

In the embodiments of this disclosure, in a scenario in which the network device configures for the first time or reconfigures the configuration information for uplink congestion failure detection and/or the configuration information for uplink congestion failure recovery for the terminal device, the terminal device can determine, based on the corresponding configuration information, how to further execute the uplink congestion failure detection and/or uplink congestion failure recovery. In this way, it is avoided that the terminal device does not know how to proceed further after obtaining the corresponding configuration information, which causes the terminal device unable to perform the uplink congestion failure detection or uplink congestion failure recovery in a timely manner.

The technical solutions provided in this application can be applied to various communications systems, such as a 5G communications system, a future evolved system, or a plurality of communication fusion systems. A plurality of application scenarios may be included, such as machine to machine (M2M), D2M, macro-micro communications, enhanced mobile broadband (eMBB), ultra reliable and low latency communications (uRLLC), and massive machine type communications (mMTC). These scenarios include, but are not limited to, scenarios such as communication between terminal devices, communication between network devices, or communication between a network device and a terminal device. The embodiments of this disclosure may be applied to communication between a network device and a terminal device, or communication between terminal devices, or communication between network devices in a 5G communications system.

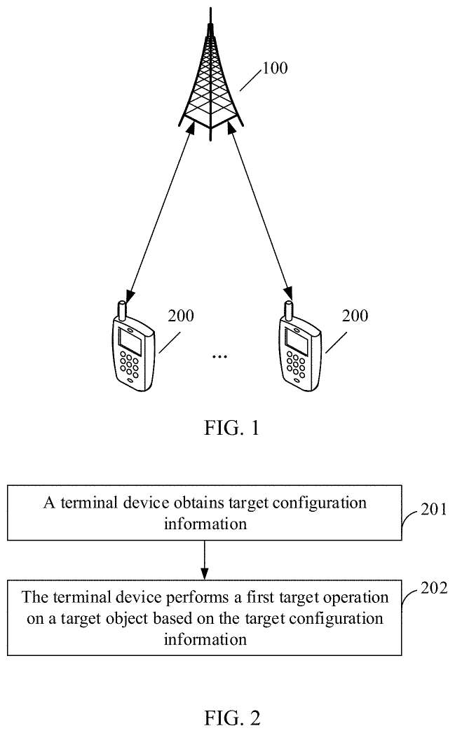

FIG. 1 is a possible schematic structural diagram of a communications system in an embodiment of this disclosure. As shown in FIG. 1, the communications system includes at least one network device 100 (only one is shown in FIG. 1) and one or more terminal devices 200 connected to each network device 100.

The network device 100 may be a base station, a core network device, a transmission and reception point (TRP), a relay station, an access point, or the like. The network device 100 may be a base transceiver station (BTS) in a global system for mobile communications (GSM) or code division multiple access (CDMA) system, may be an NB (NodeB) in a wideband code division multiple access (WCDMA) system, or may be an eNB or eNodeB (evolved NodeB) in LTE. The network device 100 may alternatively be a wireless controller in a cloud radio access network (CRAN) scenario. The network device 100 may alternatively be a network device in a 5G communications system or a network device in a future evolved network. However, the terms used do not constitute any limitation on this application.

The terminal device 200 may be a wireless terminal device or may be a wired terminal device. The wireless terminal device may be a device that provides voice and/or other service data connectivity to a user, a handheld device having a wireless communication function, a computing device or other processing devices connected to a wireless modem, an in-vehicle device, a wearable device, a terminal device in a future 5G network, or a terminal device in a future evolved PLMN network, or the like. The wireless terminal device may communicate with one or more core networks via a radio access network (RAN). The wireless terminal device may be a mobile terminal device such as a mobile phone (or referred to as “cellular” phone) and a computer having a mobile terminal device, such as a portable, pocket-sized, handheld, computer built-in, or in-vehicle mobile apparatus, which exchanges voice and/or data with the radio access network; or may be a device such as a personal communication service (PCS) phone, a cordless phone, a session initiation protocol (SIP) phone, a wireless local loop (WLL) station, or a personal digital assistant (PDA). The wireless terminal device may also be a mobile device, UE, a UE terminal device, an access terminal device, a wireless communication device, a terminal device unit, a terminal device station, a mobile station, a mobile, a remote station, a remote site, a remote terminal device (Remote Terminal), a subscriber unit, a subscriber station, a user agent, a terminal device apparatus, or the like. In an example, in this embodiment of this disclosure, a terminal device shown in FIG. 1 is a mobile phone.

FIG. 2 is a schematic flowchart of a configuration method according to an embodiment of this disclosure. As shown in FIG. 2, the configuration method may include step 201 and step 202.

Step 201: A terminal device obtains target configuration information.

Optionally, the target configuration information may be configured by a network device for the terminal device. For example, the network device may generate the target configuration information, and transmit the target configuration information to the terminal device.

Optionally, the target configuration information may be transmitted to the terminal device based on a decision from the network device, or requested from the network device based on a decision from the terminal device (for example, the terminal device sends a request to the network device when an uplink transmission failure occurs).

It should be emphasized that the network device may transmit the target configuration information when establishing a connection with the terminal device (for example, establishing a wireless connection), or may transmit the target configuration information after the connection with the terminal device is established. In this way, the network device and the terminal device can maintain consistency of the target configuration information in real time.

Optionally, the target configuration information may include at least one of the following: configuration information for uplink congestion failure detection or configuration information for uplink congestion failure recovery.

Optionally, the configuration information for uplink congestion failure detection may include at least one of the following items that correspond to the uplink congestion detection: an uplink signal, an uplink channel, a frequency, a cell, timer (that is, a timer used for uplink congestion failure detection) information, or counter (that is, a counter used for uplink congestion failure detection) information. Specifically, the configuration information for uplink congestion failure detection includes at least one of timer information and counter information that correspond to the uplink congestion detection. Certainly, the configuration information for uplink congestion failure detection includes, but is not limited to, various information listed above, and may also include other information, which is not described in this embodiment of this application.

Optionally, after the terminal device obtains the configuration information for uplink congestion failure detection, an uplink signal transmitted by the terminal device may be an uplink signal in the configuration information for uplink congestion failure detection, an uplink channel carried by the uplink signal transmitted by the terminal device may be an uplink channel in the configuration information for uplink congestion failure detection, a frequency at which the terminal device transmits the uplink signal may be a frequency in the configuration information for uplink congestion failure detection, and a cell in which the terminal device transmits the uplink signal may be a cell in the configuration information for uplink congestion failure detection.

Optionally, the configuration information for uplink congestion failure recovery may include at least one of the following items that correspond to the uplink congestion recovery: an uplink signal, an uplink channel, a frequency, a cell, timer information, counter information, and the like. Specifically, the configuration information for uplink congestion failure recovery includes at least one of timer (that is, a timer used for uplink congestion failure recovery) information or counter (that is, a counter used for uplink congestion failure recovery) information that correspond to the uplink congestion recovery. Certainly, the configuration information for uplink congestion failure recovery includes, but is not limited to, various information listed above, and may also include other information, which is not described in this embodiment of this application.

Similarly, for a detailed description of the uplink signal, uplink channel, frequency, and cell in the configuration information for uplink congestion failure recovery, reference may be made to the above descriptions of the uplink signal, uplink channel, frequency, and cell in the configuration information for uplink congestion failure detection, and details are not described again in this embodiment of this disclosure.

Optionally, in a case that the target configuration information includes the configuration information for uplink congestion failure detection and the configuration information for uplink congestion failure recovery, a time sequence for the terminal device to obtain the configuration information for uplink congestion failure detection and the configuration information for uplink congestion failure recovery is not specifically limited, and may be any achievable time sequence. For example, the terminal device may first obtain the configuration information for uplink congestion failure detection, and then obtain the configuration information for uplink congestion failure recovery, so as to obtain the target configuration information.

Step 202: The terminal device performs a first target operation on a target object based on the target configuration information.

Optionally, the target object may include at least one of the following: a target timer or a target counter.

Optionally, in a case that the target object includes the target timer, the first target operation includes at least one of the following: starting the target timer, restarting the target timer, and stopping the target timer; and/or

in a case that the target object includes the target counter, the first target operation includes at least one of the following: updating a threshold of the target counter, or resetting the target counter.

Optionally, the step 202 may be implemented by performing the following step 1 to step 6.

Step 1: The terminal device starts the target timer in a case that the target object is the target timer and that the target configuration information is configured for the first time.

Step 2: The terminal device starts the target timer in a case that the target object is the target timer, that the target timer is not started, and that the target configuration information is reconfigured.

It can be understood that when the target configuration information is configured by a network device for the terminal device, the terminal device may start the target timer to start performing the uplink congestion failure detection and/or uplink congestion failure recovery.

Optionally, in a case that the target object is the target timer, the target configuration information may include a value of duration of the target timer, and the terminal device may update its duration to a corresponding duration in the target configuration information.

Step 3: The terminal device restarts or stops the target timer in a case that the target object is the target timer, that the target timer has already been started, and that the target configuration information is reconfigured.

Specifically, the terminal device may directly restart the target timer, or may first stop the target timer, and then restart the target timer after a period of time.

It can be understood that the terminal device restarts the target timer, so as to start performing the uplink congestion failure detection and/or uplink congestion failure recovery.

Step 4: The terminal device updates a threshold of the target counter in a case that the target object is the target counter and that the target configuration information is configured for the first time.

Step 5: The terminal device updates a threshold of the target counter in a case that the target object is the target counter and that the target configuration information is reconfigured.

It can be understood that the terminal device can control the target counter to continuously count, and update the threshold of the target counter.

Step 6: The terminal device resets the timer in a case that the target object is the target counter and that the target configuration information is reconfigured.

It can be understood that the terminal device resets the target counter and updates the threshold of the target counter, so as to start performing the uplink congestion failure detection and/or uplink congestion failure recovery.

### Example 1

In Example 1 provided in an embodiment of this disclosure, the target configuration information is the configuration information for uplink congestion failure detection.

Specifically, the configuration method provided in this embodiment of this disclosure may be applied to a process in which the network device configures or reconfigures configuration information for uplink congestion failure detection for the terminal device, or a process in which the network device activates or deactivates the configuration information for uplink congestion failure detection for the terminal device.

The configuration information for uplink congestion failure detection includes an uplink signal, an uplink channel, a frequency, a cell, timer information, and counter information that correspond to the uplink congestion failure detection

Optionally, in Example 1, the target timer is a first timer, the target counter is a first counter, and a threshold of the first counter is an uplink congestion failure detection threshold. To be specific, a target object includes at least one of the following: the first timer and the first counter, and both the first timer and the first counter are used for uplink congestion failure detection.

Duration of the first timer is a time length for the terminal device to perform uplink congestion failure detection (for example, a time length configured by a network device through the configuration information for uplink congestion failure detection, or a time length specified by a protocol), and the threshold of the first counter is an uplink congestion failure detection threshold currently configured by the network device.

Optionally, in Example 1, in a scenario in which the target object includes the first timer, the configuration information for uplink congestion failure detection may include information about the first timer, for example, the duration of the first timer.

Stopping the first timer means that the terminal device restores the timing value of the first timer to an initial value (for example, “0”), but does not start the first timer. Starting or restarting the first timer means that the terminal device restores the timing value of the first timer to an initial value (for example, “0”), and starts the first timer.

Optionally, in a case that the target object includes the first timer, the terminal device can start or restart the first timer through step 203, that is, step 202 can be implemented by performing step 203.

Step 203: The terminal device starts or restarts the first timer in a case that the terminal device meets a first condition.

The first condition includes at least one of the following condition 1 and condition 2.

Condition 1. An uplink signal is transmitted for the first time after the terminal device obtains the configuration information for uplink congestion failure detection.

Condition 2. An uplink signal transmission failure occurs for the first time after the terminal device obtains the configuration information for uplink congestion failure detection. For example, the terminal device experiences an uplink signal transmission failure for the first time due to LBT failure (that is, LBT failure).

Specifically, upon obtaining the configuration information for uplink congestion failure detection, the terminal device may determine which operation of the steps 1 to 3 is to be performed on the first timer.

Specifically, when the terminal device obtains the configuration information for uplink congestion failure detection, if the terminal device has not yet started to perform the uplink congestion failure detection (that is, the first timer is not started up), the terminal device starts the first timer; and if the terminal device has already started to perform the uplink congestion failure detection (that is, the first timer has already been started up), the terminal device restarts the first timer.

Optionally, the terminal device may first stop the first timer, and then restart the first timer.

It can be understood that when the terminal device obtains the configuration information for uplink congestion failure detection, if the terminal device does not meet the foregoing first condition, it indicates that the terminal device currently has a low probability of uplink congestion failure, meaning that the terminal device currently does not need to perform the uplink congestion failure detection. In this way, in a case that the terminal device currently has a low probability of uplink congestion failure, the terminal device can stop without starting the first timer, so that it does not start to perform the uplink congestion failure detection, thereby helping reduce operating resources of the terminal device.

Optionally, in Example 1, in a scenario in which the target object includes the first counter, the configuration information for uplink congestion failure detection may include information about the first counter, for example, an uplink congestion failure detection threshold of the first counter (that is, a threshold of the first counter).

For example, currently the terminal device sets a count value of the first counter to counter1=3, and the current threshold of the first counter is threshold1=4. In this case, in the scenario in which the configuration information for uplink congestion failure detection is obtained by the terminal device and an uplink congestion failure detection threshold of the first counter in the configuration information for uplink congestion failure detection is threshold1=6, the terminal device can make the first counter continue to count from the current counter1=3 through step 5, and modify the threshold of the first counter from the current threshold1=4 to threshold1=6.

In step 6, resetting the first counter refers to resetting the count value of the first counter to an initial value (for example, “0”), and updating the threshold of the first counter.

For example, in Example 1, each time the terminal device detects an uplink congestion failure, the count value counter1 of the first counter can be increased by 1. For example, currently the terminal device sets a count value of the first counter to counter1=3, and the current threshold of the first counter is threshold1=4. In this case, in the scenario in which the configuration information for uplink congestion failure detection is obtained by the terminal device and an uplink congestion failure detection threshold of the first counter in the configuration information for uplink congestion failure detection is threshold1=6, the terminal device can reset the count value of the first counter from the current counter1=3 to counter1=0 through step 6, and modify the threshold of the first counter from threshold1=4 to threshold1=6.

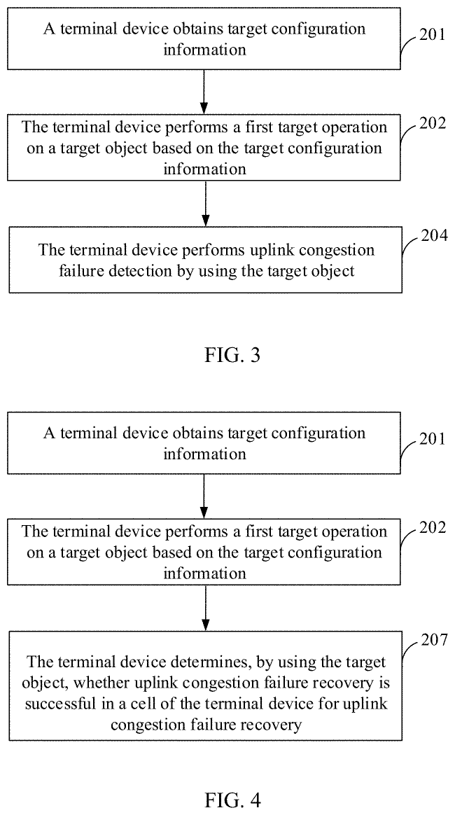

Further, in Example 1, with reference to FIG. 2, as shown in FIG. 3, a configuration method provided in an embodiment of this disclosure may further include step 204 after the step 202.

Step 204: The terminal device performs uplink congestion failure detection by using the target object.

Specifically, the terminal device may implement step 204 through step 204a or step 204b.

Step 204a: The terminal device performs uplink congestion failure detection by using the first counter.

In a case that the target object includes the first counter, if the count value of the first counter is greater than or equal to the uplink congestion failure detection threshold, it is determined that an uplink congestion failure has occurred. In this case, the terminal device may perform an operation related to an uplink congestion failure event, for example, starting to perform uplink congestion failure recovery, to allow the terminal device to successfully transmit uplink signals. On the contrary, if the count value of the first counter is less than the uplink congestion failure detection threshold of the first counter, it is determined that no uplink congestion failure occurs.

For example, when the threshold of the first counter is the uplink congestion failure detection threshold threshold1=6 currently configured by the network device, if the terminal device determines that the count value counter1 of the first counter is greater than or equal to 6, it indicates that the terminal device has experienced an uplink congestion failure, and then the terminal device can perform a related operation for the uplink congestion failure.

Step 204b: The terminal device performs uplink congestion failure detection by using the first timer and the first counter.

Within the duration of the first timer, if the count value of the first counter is greater than or equal to the uplink congestion failure detection threshold of the first counter, it is determined that an uplink congestion failure has occurred; otherwise, within the duration of the first timer, if the count value of the first counter is less than the uplink congestion failure detection threshold, it is determined that no uplink congestion failure occurs.

For example, when the threshold of the first counter is the uplink congestion failure detection threshold threshold1=6 currently configured by the network device, if within the duration of the first timer, the terminal device determines that the count value counter1 of the first counter is greater than or equal to 6, it indicates that the terminal device has experienced an uplink congestion failure, and then the terminal device can perform a related operation for the uplink congestion failure, for example, performing uplink congestion failure recovery.

### Example 2

In Example 2 provided in an embodiment of this disclosure, the target configuration information is the configuration information for uplink congestion failure recovery.

Specifically, the configuration method provided in this embodiment of this disclosure may be applied to a process in which the network device configures or reconfigures configuration information for uplink congestion failure recovery for the terminal device, or a process in which the network device activates or deactivates the configuration information for uplink congestion failure recovery for the terminal device.

The configuration information for uplink congestion failure recovery includes an uplink signal, an uplink channel, a frequency, a cell, a timer, a counter, and other information that correspond to the uplink congestion failure recovery.

Optionally, in Example 2, the target timer is a second timer, the target counter is a second counter, and a threshold of the second counter is an uplink congestion failure recovery threshold. To be specific, a target object includes at least one of the following: the second timer and the second counter, and both the second timer and the second counter are used for uplink congestion failure recovery.

Duration of the second timer is a time length in which the terminal device performs uplink congestion failure recovery (for example, a time length configured by a network device through the configuration information for uplink congestion failure recovery, or a time length specified by a protocol), and the threshold of the second counter is an uplink congestion failure recovery threshold currently configured by the network device.

Optionally, in a scenario in which the target timer is the second timer, the configuration information for uplink congestion failure recovery may include information about the second timer, for example, the duration of the second timer.

Stopping the second timer means that the terminal device restores the timing value of the second timer to an initial value (for example, “0”), but does not start the second timer. Starting or restarting the second timer means that the terminal device restores the timing value of the second timer to an initial value (for example, “0”), and starts the second timer.

Optionally, in a case that the target object is the second timer, the terminal device can start or restart the second timer through step 205, that is, step 202 can be implemented through step 205.

Step 205: The terminal device starts or restarts the second timer in a case that the terminal device meets a second condition.

The second condition includes at least one of the following condition 3 or condition 4.

Condition 3. An uplink congestion failure occurs after the terminal device obtains the configuration information for uplink congestion failure recovery.

For example, if the terminal device has experienced the uplink congestion failure on a currently activated BWP (denoted as BWP1), the terminal device starts or restarts the second timer. Later, after the terminal device switches to BWP2, if the terminal device performs the uplink congestion failure recovery, it is detected within the duration of the second timer, whether an uplink congestion failure has occurred in a cell of the terminal device for uplink congestion failure recovery, so that it can be determined whether the uplink congestion failure recovery is successful. For example, after the terminal device switches to BWP2, if the terminal device has experienced one uplink congestion failure within the duration of the second timer, the terminal device determines that the uplink congestion failure recovery fails.

Optionally, the BWP2 to which the terminal device switches may be a BWP in the configuration information for uplink congestion failure recovery, that is, a frequency corresponding to the uplink congestion failure recovery.

Condition 4. A frequency carrying an uplink signal is activated or changed to another frequency after the terminal device obtains the configuration information for uplink congestion failure recovery.

For example, the terminal device may start or restart the second timer when switching a currently activated BWP1 to BWP2 (or activating BWP2). In this way, the terminal device may determine that within the duration of the second timer, whether an uplink congestion failure has occurred in a cell of the terminal device for uplink congestion failure recovery, and then determine whether the uplink congestion failure recovery is successful.

Condition 5. A secondary cell (SCell) of the terminal device for uplink congestion failure recovery is activated after the terminal device obtains the configuration information for uplink congestion failure recovery.

Condition 6. A secondary cell of the terminal device for uplink congestion failure recovery is added after the terminal device obtains the configuration information for uplink congestion failure recovery.

Optionally, the foregoing secondary cell of the terminal device may be a secondary cell in the configuration information for uplink congestion failure recovery.

It can be understood that upon obtaining the configuration information for uplink congestion failure recovery, the terminal device may determine which operation of the steps 1 to 3 is to be performed on the second timer.

For example, when the terminal device obtains the configuration information for uplink congestion failure recovery, if the terminal device has not yet started to perform the uplink congestion failure recovery (that is, the second timer is not started up), the terminal device starts the second timer; and if the terminal device has already started to perform the uplink congestion failure recovery (that is, the second timer has already been started up), the terminal device restarts the second timer.

Optionally, in a case that the configuration information for uplink congestion failure recovery is reconfigured, the terminal device may first deactivate the second timer, and then restart the second timer after a period of time.

It can be understood that when the terminal device obtains the configuration information for uplink congestion failure recovery, if the terminal device does not meet the foregoing second condition, it indicates that the terminal device currently has a low probability of uplink congestion failure, meaning that the terminal device currently does not need to perform the uplink congestion failure recovery. In this way, in a case that the terminal device does not need to perform the uplink congestion failure recovery, the terminal device can stop the second timer, instead of starting the second timer, that is, does not start to perform the uplink congestion failure recovery, thereby helping reduce operating resources of the terminal device.

Optionally, in Example 2, in a scenario in which the target counter is the second counter, the configuration information for uplink congestion failure recovery may include information about the second counter, for example, an uplink congestion failure detection threshold of the second counter (that is, a threshold of the second counter).

In the step 4, updating the threshold of the second counter means that the terminal device controls the second counter to start counting, and updates the threshold of the second counter to the uplink congestion failure recovery threshold in the configuration information for uplink congestion failure recovery.

In the step 5, updating the threshold of the second counter means that the terminal device controls the second counter to keep counting, and updates the threshold of the second counter to the uplink congestion failure recovery threshold in the configuration information for uplink congestion failure recovery.

For example, currently the terminal device sets a count value of the second counter to counter2=2, and the current threshold of the second counter is threshold2=2. In this case, in the scenario in which the configuration information for uplink congestion failure recovery is obtained by the terminal device and an uplink congestion failure recovery threshold of the second counter in the configuration information for uplink congestion failure recovery is threshold2=3, the terminal device can make the second counter continue to count from the current counter2=2 through step 5, and modify the threshold of the second counter from the current threshold2=2 to threshold2=3.

In the step 6, resetting the second counter refers to resetting the count value of the second counter to an initial value (for example, “0”).

For example, in a case that the terminal device performs the uplink congestion failure recovery, each time the terminal detects an uplink congestion failure event, the count value counter2 of the second counter can be increased by 1. For example, currently the terminal device sets a count value of the second counter to counter2=2, and the current threshold of the second counter is threshold2=2. In this case, in the scenario in which the configuration information for uplink congestion failure recovery is obtained by the terminal device and an uplink congestion failure recovery threshold of the second counter in the configuration information for uplink congestion failure recovery is threshold2=3, the terminal device can reset the count value of the second counter from counter2=2 to counter2=0 through the step 6, and modify the threshold of the second counter from threshold2=2 to threshold2=3.

Further, optionally, in a case that the target timer is the second timer, the terminal device can stop the second timer through step 206, that is, step 202 can be implemented by performing step 206.

Step 206: The terminal device stops the second timer in a case that the terminal device meets a third condition.

The third condition includes at least one of the following condition 7 to condition 9.

Condition 7. A frequency carrying an uplink signal is deactivated or changed to another frequency after the terminal device obtains the configuration information for uplink congestion failure recovery.

For example, after the terminal device activates a BWP (for example, BWP1) and starts the second timer, when the terminal device is performing the uplink congestion failure recovery, if the terminal device activates or changes to another BWP (for example, BWP3), the terminal device controls the second timer to stop timing.

Condition 8. A secondary cell of the terminal device for uplink congestion failure recovery is deactivated after the terminal device obtains the configuration information for uplink congestion failure recovery.

Condition 9. A secondary cell of the terminal device for uplink congestion failure recovery is removed after the terminal device obtains the configuration information for uplink congestion failure recovery.

Similarly, for descriptions of condition 8 and condition 9, reference may be made to related descriptions of condition 5 and condition 6 in the foregoing embodiment, and details are not described again in this embodiment of this disclosure.

Further, in Example 2, the configuration method provided in this embodiment of this disclosure may further include step 207 after the step 202 or the step 204. As shown in FIG. 4, after the step 202, the method may further include step 207.

Step 207: The terminal device determines, by using the target object, whether uplink congestion failure recovery is successful in a cell of the terminal device for uplink congestion failure recovery.

Specifically, the terminal device may implement step 207 through step 207a or step 207b.

Step 207a: The terminal device determines, by using the second counter, whether uplink congestion failure recovery is successful in a cell of the terminal device for uplink congestion failure recovery.

Specifically, in a case that the target object includes the second counter, if the count value of the second counter is greater than or equal to the uplink congestion failure recovery threshold, it is determined that the uplink congestion failure recovery has failed in the cell of the terminal device for uplink congestion failure recovery. In this case, the terminal device may handle the failure in uplink congestion failure recovery. On the contrary, if the count value of the second counter is less than the uplink congestion failure recovery threshold, it is determined that the uplink congestion failure recovery is successful in the cell of the terminal device for uplink congestion failure recovery.

For example, when the threshold of the second counter is the uplink congestion failure recovery threshold threshold2=3 currently configured by the network device, if the terminal device determines that the count value counter2 of the second counter is greater than or equal to 3, it indicates that the terminal device has failed in uplink congestion failure recovery, and then the terminal device can perform related processing for the failure in uplink congestion failure recovery.

Step 207b: The terminal device determines, by using the second timer and the second counter, whether uplink congestion failure recovery is successful in a cell of the terminal device for uplink congestion failure recovery.

Specifically, in a case that the target object includes the second counter and the second timer, within the duration of the second timer, if the count value of the second counter is greater than or equal to the uplink congestion failure recovery threshold, it is determined that the uplink congestion failure recovery has failed in the cell of the terminal device for uplink congestion failure recovery. On the contrary, within the duration of the second timer, if the count value of the second counter is less than the uplink congestion failure recovery threshold, it is determined that the uplink congestion failure recovery is successful in the cell of the terminal device for uplink congestion failure recovery.

For example, when the threshold of the second counter is the uplink congestion failure recovery threshold threshold2=3 currently configured by the network device, if the terminal device determines within the duration (for example, 10 seconds) of the second timer that the count value counter2 of the second counter is greater than or equal to 3, it indicates that the uplink congestion failure recovery has failed, and then related processing can be performed for the failure in uplink congestion failure recovery failure.

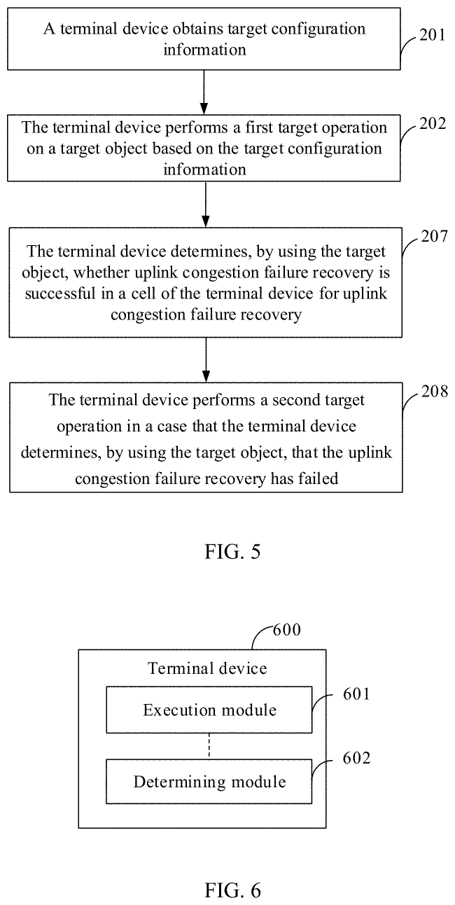

Further, with reference to FIG. 4, as shown in FIG. 5, a configuration method provided in an embodiment of this disclosure may further include step 208 after the step 207.

Step 208: The terminal device performs a second target operation in a case that the terminal device determines, by using the target object, that the uplink congestion failure recovery has failed.

The second target operation includes at least one of the following: a first operation or a second operation; the first operation is that the terminal device triggers a wireless connection re-establishment procedure; and the second operation is that the terminal device transmits failure information to the network device, where the failure information is used to indicate that the uplink congestion failure recovery has failed in a cell of the terminal device for uplink congestion failure recovery.

Specifically, the terminal device can distinguish types of cells in which the uplink congestion failure recovery is performed, and perform different second target operations for different types of cells. There may be four cases as far as the terminal device performs the second target operation:

(1) In a case that the uplink congestion failure recovery has failed in a primary cell of the terminal device, the second target operation includes at least one of the following: the first operation or the second operation. Specifically, the terminal device may transmit, to the network device, a failure message through a secondary cell in a master cell group, or a cell (for example, a primary secondary cell or a secondary cell) in a secondary cell group, to perform the second operation.

(2) In a case that the uplink congestion failure recovery has failed in all cells in a master cell group of the terminal device, the second target operation includes at least one of the following: the first operation or the second operation. Specifically, the terminal device may transmit, to the network device, a failure message through a cell (for example, a primary secondary cell or a secondary cell) in a secondary cell group, to perform the second operation.

(3) In a case that the uplink congestion failure recovery has failed in all cells in a secondary cell group of the terminal device, the second target operation is the second operation. Specifically, the terminal device may transmit a failure message, to the network device, through a cell (for example, a primary secondary cell or a secondary cell) in a secondary cell group, to perform the second operation.

(4) In a case that the uplink congestion failure recovery has failed in a primary secondary cell of the terminal device, the second target operation is the second operation. Specifically, the terminal device may transmit a failure message through a cell in a master cell group, or a secondary cell in a secondary cell group, to perform the second operation.

Optionally, in a case that the second target operation includes the first operation and the second operation, the time sequence for the terminal device to perform the first operation and the second operation is not specifically limited. For example, the terminal device may first perform the second operation, and then perform the first operation.

In the embodiments of this disclosure, because the terminal device can update in real time the configuration information for uplink congestion failure recovery configured by the network device for uplink congestion failure recovery, to ensure the consistency of the configuration information for uplink congestion failure recovery in the network device and the terminal device, the terminal device can control in real time, based on the configuration information for uplink congestion failure recovery, how many times and when to perform the uplink congestion failure recovery procedure, thereby preventing the terminal device from repeatedly transmitting an uplink congestion failure in a same cell. This further helps improve reliability of the uplink congestion failure recovery performed by the terminal device, and helps the terminal device to successfully transmit uplink signals.

Further, in this embodiment of this disclosure, for examples in which the target configuration information includes the configuration information for uplink congestion failure detection and the configuration information for uplink congestion failure recovery, reference may be made to related descriptions in Example 1 and Example 2 in the foregoing embodiments, and details are not described again in this embodiment of this disclosure.

It should be noted that in the configuration method provided in the embodiments of this disclosure, in a scenario in which the network device configures for the first time or reconfigures the configuration information for uplink congestion failure detection and/or the configuration information for uplink congestion failure recovery for the terminal device, the terminal device can determine, based on the corresponding configuration information, how to further execute the uplink congestion failure detection and/or the uplink congestion failure recovery. In this way, it is avoided that the terminal device does not know how to proceed further after obtaining the corresponding configuration information, which causes the terminal device unable to perform the uplink congestion failure detection or uplink congestion failure recovery in a timely manner.

FIG. 6 is a possible schematic structural diagram of a terminal device provided for implementation of the embodiments of this disclosure. As shown in FIG. 6, the terminal device 600 includes an execution module 601. Specifically, the execution module 601 is configured to perform a first target operation on a target object based on target configuration information, where in a case that the target configuration information is configuration information for uplink congestion failure detection, the target object is used for uplink congestion failure detection; and/or in a case that the target configuration information is configuration information for uplink congestion failure recovery, the target object is used for uplink congestion failure recovery.

Optionally, the target object includes at least one of the following: a target timer or a target counter. In a case that the target object includes the target timer, the first target operation includes at least one of the following: starting the target timer, restarting the target timer, or stopping the target timer; and/or in a case that the target object includes the target counter, the first target operation includes at least one of the following: updating a threshold of the target counter, or resetting the target counter.

Optionally, the execution module is specifically configured to: start the target timer in a case that the target object is the target timer and that the target configuration information is configured for the first time; or

start the target timer in a case that the target object is the target timer, that the target timer is not started, and that the target configuration information is reconfigured; or

restart or stop the target timer in a case that the target object is the target timer, that the target timer has been started, and that the target configuration information is reconfigured; or

update a threshold of the target counter in a case that the target object is the target counter and that the target configuration information is configured for the first time; or

update a threshold of the target counter in a case that the target object is the target counter and that the target configuration information is reconfigured; or

reset the target counter in a case that the target object is the target counter and that the target configuration information is reconfigured.

Optionally, in a case that the target configuration information is the configuration information for uplink congestion failure detection, the target timer is a first timer, the target counter is a first counter, and a threshold of the first counter is an uplink congestion failure detection threshold.

Optionally, the target timer is the first timer, and the execution module 601 is specifically configured to start or restart the first timer in a case that the terminal device meets a first condition, where the first condition includes at least one of the following: an uplink signal is transmitted for the first time after the configuration information for uplink congestion failure detection is obtained; or an uplink signal transmission failure occurs for the first time after the configuration information for uplink congestion failure detection is obtained.

Optionally, in a case that the target configuration information is the configuration information for uplink congestion failure recovery, the target timer is a second timer, the target counter is a second counter, and a threshold of the second counter is an uplink congestion failure recovery threshold.

Optionally, the target timer is the second timer, and the execution module 601 is specifically configured to start or restart the second timer in a case that the terminal device meets a second condition, where the second condition includes at least one of the following: an uplink congestion failure occurs after the configuration information for uplink congestion failure recovery is obtained; a frequency carrying an uplink signal is activated or changed to another frequency after the configuration information for uplink congestion failure recovery is obtained; a secondary cell of the terminal device for uplink congestion failure recovery is activated after the configuration information for uplink congestion failure recovery is obtained; or a secondary cell of the terminal device for uplink congestion failure recovery is added after the configuration information for uplink congestion failure recovery is obtained.

Optionally, the execution module 601 is specifically configured to stop the second timer in a case that the terminal device meets a third condition, where the third condition includes at least one of the following: a frequency carrying an uplink signal is deactivated or changed to another frequency after the configuration information for uplink congestion failure recovery is obtained; a secondary cell of the terminal device for uplink congestion failure recovery is deactivated after the configuration information for uplink congestion failure recovery is obtained; or a secondary cell of the terminal device for uplink congestion failure recovery is removed after the configuration information for uplink congestion failure recovery is obtained.

Optionally, the terminal device 600 further includes a determining module 602, where the determining module 602 is configured to determine, by using the target object, whether uplink congestion failure recovery is successful in a cell of the terminal device for uplink congestion failure recovery.

Optionally, the determining module 602 is specifically configured to: in a case that the target object includes the second counter, if a count value of the second counter is greater than or equal to the uplink congestion failure recovery threshold, determine that the uplink congestion failure recovery has failed in the cell of the terminal device for uplink congestion failure recovery; and in a case that the target object includes the second counter and the second timer, within duration of the second timer, if the count value of the second counter is greater than or equal to the uplink congestion failure recovery threshold, determine that the uplink congestion failure recovery has failed in the cell of the terminal device for uplink congestion failure recovery.

Optionally, the execution module 601 is further configured to: in a case that the determining module 602 determines, by using the target object, that the uplink congestion failure recovery has failed in the cell of the terminal device for uplink congestion failure recovery, perform a second target operation, where the second target operation includes at least one of the following: a first operation or a second operation; the first operation is to trigger a wireless connection re-establishment procedure; and the second operation is to transmit failure information to the network device, where the failure information is used to indicate that the uplink congestion failure recovery has failed.

Optionally, in a case that the uplink congestion failure recovery has failed in a primary cell of the terminal device, the second target operation includes at least one of the following: the first operation or the second operation; or

in a case that the uplink congestion failure recovery has failed in all cells in a master cell group of the terminal device, the second target operation includes at least one of the following: the first operation or the second operation; or

in a case that the uplink congestion failure recovery has failed in all cells in a secondary cell group of the terminal device, the second target operation is the second operation; or

in a case that the uplink congestion failure recovery has failed in a primary secondary cell of the terminal device, the second target operation is the second operation; or

in a case that the uplink congestion failure recovery has failed in a secondary cell of the terminal device, the second target operation is the second operation.

The terminal device provided in this embodiment of this disclosure can implement the processes shown in any one of FIG. 2 to FIG. 5 in the foregoing method embodiments. To avoid repetition, details are not described herein again.

It should be noted that in the terminal device provided in this embodiment of this disclosure, in a scenario in which a network device configures for the first time or reconfigures the configuration information for uplink congestion failure detection and/or the configuration information for uplink congestion failure recovery for the terminal device, the terminal device can determine, based on the corresponding configuration information, how to further execute uplink congestion failure detection and/or the uplink congestion failure recovery. In this way, it is avoided that the terminal device does not know how to proceed further after obtaining the corresponding configuration information, which causes the terminal device unable to perform the uplink congestion failure detection or uplink congestion failure recovery in a timely manner.

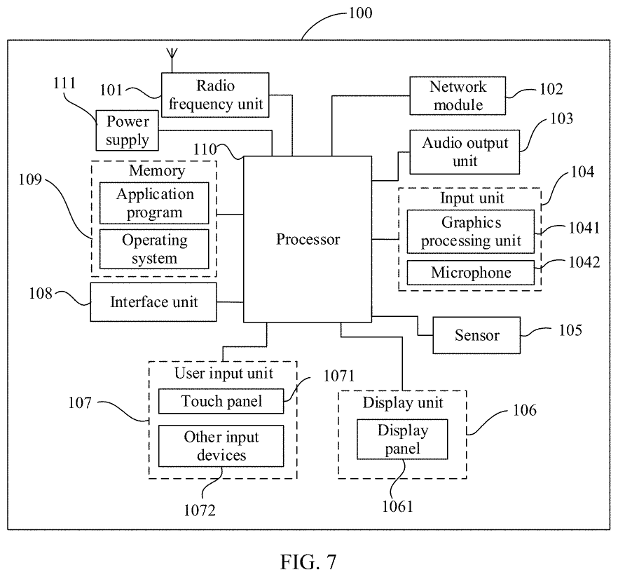

FIG. 7 is a schematic diagram of a hardware structure of a terminal device for implementing the embodiments of this application. The terminal device 100 includes but is not limited to components such as a radio frequency unit 101, a network module 102, an audio output unit 103, an input unit 104, a sensor 105, a display unit 106, a user input unit 107, an interface unit 108, a memory 109, a processor 110, and a power supply 111. A person skilled in the art can understand that the structure of the terminal device 100 shown in FIG. 7 does not constitute any limitation on the terminal device. The terminal device 100 may include more or fewer components than those shown in the figure, or a combination of some components, or the components disposed differently. In this embodiment of this disclosure, the terminal device 100 includes but is not limited to a mobile phone, a tablet computer, a laptop computer, a palmtop computer, an in-vehicle terminal device, a wearable device, a pedometer, and the like.

The processor 110 is configured to perform a first target operation on a target object based on target configuration information, where in a case that the target configuration information is configuration information for uplink congestion failure detection, the target object is used for uplink congestion failure detection;

and/or in a case that the target configuration information is configuration information for uplink congestion failure recovery, the target object is used for uplink congestion failure recovery.

In the terminal device provided in this embodiment of this disclosure, in a scenario in which a network device configures for the first time or reconfigures the configuration information for uplink congestion failure detection and/or the configuration information for uplink congestion failure recovery for the terminal device, the terminal device can determine, based on the corresponding configuration information, how to further execute uplink congestion failure detection and/or the uplink congestion failure recovery. In this way, it is avoided that the terminal device does not know how to proceed further after obtaining the corresponding configuration information, which causes the terminal device unable to perform the uplink congestion failure detection or uplink congestion failure recovery in a timely manner.

It should be understood that, in this embodiment of this disclosure, the radio frequency unit 101 may be configured to transmit or receive a signal in an information transmitting/receiving or call process. Specifically, the radio frequency unit 101 receives downlink data from a base station and transmits the downlink data to the processor 110 for processing; and transmits uplink data to the base station. Typically, the radio frequency unit 101 includes but is not limited to an antenna, at least one amplifier, a transceiver, a coupler, a low noise amplifier, a duplexer, and the like. In addition, the radio frequency unit 101 may also communicate with a network and other devices via a wireless communications system.

The terminal device 100 provides the user with wireless broadband Internet access by using the network module 102, for example, helping the user send or receive an email , browse a web page, and access streaming media.

The audio output unit 103 may convert audio data received by the radio frequency unit 101 or the network module 102 or stored in the memory 109 into an audio signal and output the audio signal as a sound. In addition, the audio output unit 103 may further provide audio output (for example, a call signal received sound or a message received sound) related to a specific function performed by the terminal device 100. The audio output unit 103 includes a speaker, a buzzer, a telephone receiver, and the like.

The input unit 104 is configured to receive an audio or video signal. The input unit 104 may include a graphics processing unit (GPU) 1041 and a microphone 1042, and the graphics processing unit 1041 processes image data of a still picture or a video obtained by an image capture apparatus (for example, a camera) in an image capture mode or a video capture mode. A processed image frame may be displayed on the display unit 106. An image frame processed by the graphics processing unit 1041 may be stored in the memory 109 (or another storage medium) or transmitted by the radio frequency unit 101 or the network module 102. The microphone 1042 can receive a sound and can process the sound into audio data. The processed audio data can be converted in a telephone call mode into a format that can be sent to a mobile communication base station through the radio frequency unit 101, for outputting.

The terminal device 100 further includes at least one sensor 105, for example, an optical sensor, a motion sensor, and other sensors. Specifically, the optical sensor may include an ambient light sensor and a proximity sensor. The ambient light sensor may adjust luminance of the display panel 1061 based on brightness of ambient light, and the proximity sensor may turn off the display panel 1061 and/or backlight when the terminal device 100 moves close to an ear. As a type of motion sensor, an accelerometer sensor can detect magnitudes of accelerations in all directions (usually three axes), can detect a magnitude and a direction of gravity when the terminal device is in a static state, and can be applied to terminal device posture recognition (such as screen switching between portrait and landscape, related games, and magnetometer posture calibration) of the terminal device, functions related to vibration recognition (such as pedometer and tapping), and the like. The sensor 105 may also include a fingerprint sensor, a pressure sensor, an iris sensor, a molecular sensor, a gyroscope, a barometer, a hygrometer, a thermometer, an infrared sensor, and the like. Details are not described herein.

The display unit 106 is configured to display information input by the user or information provided to the user. The display unit 106 may include the display panel 1061. The display panel 1061 may be configured in a form of a liquid crystal display (LCD), an organic light-emitting diode (OLED), or the like.

The user input unit 107 may be configured to receive entered numerical or character information, and generate key signal input that is related to user setting and function control of the terminal device 100. Specifically, the user input unit 107 may include a touch panel 1071 and other input devices 1072. The touch panel 1071, also referred to as a touchscreen, may capture a touch operation performed by a user on or near the touch panel (for example, an operation performed by the user on the touch panel 1071 or near the touch panel 1071 by using any appropriate object or accessory such as a finger or a stylus). The touch panel 1071 may include two parts: a touch detection apparatus and a touch controller. The touch detection apparatus detects a touch position of the user, detects a signal brought by the touch operation, and transmits the signal to the touch controller. The touch controller receives touch information from the touch detection apparatus, converts the touch information into touch point coordinates, transmits the touch point coordinates to the processor 110, and receives and executes a command transmitted by the processor 110. In addition, the touch panel 1071 may be implemented in a plurality of forms, for example, as a resistive, capacitive, infrared, or surface acoustic wave touch panel. The user input unit 107 may further include other input devices 1072 in addition to the touch panel 1071. Specifically, the other input devices 1072 may include but are not limited to a physical keyboard, a function key (such as a volume control key or a switch key), a trackball, a mouse, and a joystick. Details are not described herein.

Further, the touch panel 1071 may cover the display panel 1061. When detecting a touch operation on or near the touch panel 1071, the touch panel 1071 transmits the touch operation to the processor 110 to determine a type of a touch event. Then, the processor 110 provides a corresponding visual output on the display panel 1061 based on the type of the touch event. Although in FIG. 7, the touch panel 1071 and the display panel 1061 act as two separate parts to implement input and output functions of the terminal device 100, in some embodiments, the touch panel 1071 and the display panel 1061 may be integrated to implement the input and output functions of the terminal device 100. This is not specifically limited herein.

The interface unit 108 is an interface for connecting an external apparatus to the terminal device 100. For example, the external apparatus may include a wired or wireless headphone port, an external power supply (or battery charger) port, a wired or wireless data port, a memory card port, a port for connecting an apparatus with an identification module, an audio input/output (I/O) port, a video I/O port, a headset port, or the like. The interface unit 108 may be configured to receive an input (for example, data information or power) from an external apparatus and transmit the received input to one or more elements within the terminal device 100, or may be configured to transmit data between the terminal device 100 and the external apparatus.

The memory 109 may be configured to store software programs and various data. The memory 109 may mainly include a program storage region and a data storage region. The program storage region may store an operating system, an application program required by at least one function (for example, an audio play function or an image play function), and the like. The data storage region may store data (for example, audio data and a phone book) created based on usage of the mobile phone. In addition, the memory 109 may include a high-speed random access memory, or may further include a nonvolatile memory, for example, at least one magnetic disk storage device or a flash memory device, or another volatile solid-state storage device.

The processor 110 is a control center of the terminal device 100, uses various interfaces and lines to connect all parts of the entire terminal device 100, and performs various functions and data processing of the terminal device 100 by running or executing the software program and/or module stored in the memory 109 and invoking data stored in the memory 109, thereby performing overall monitoring on the terminal device 100. The processor 110 may include one or more processing units. Optionally, an application processor and a modem processor may be integrated in the processor 110. The application processor primarily processes an operating system, user interfaces, application programs, and the like. The modem processor primarily processes radio communication. It can be understood that the modem processor may alternatively be not integrated in the processor 110.

The terminal device 100 may further include a power supply 111 (for example, a battery) that supplies power to each component. Optionally, the power supply 111 may be logically connected to the processor 110 by using a power management system, so as to implement functions such as charging management, discharging management, and power consumption management by using the power management system.

In addition, the terminal device 100 includes some functional modules that are not illustrated. Details are not described herein.

Optionally, an embodiment of this disclosure further provides a terminal device, including a processor, a memory, and a computer program stored in the memory and capable of running on the processor. When the computer program is executed by the processor, the processes of the configuration method in the foregoing embodiments are implemented, with the same technical effects achieved. To avoid repetition, details are not described again herein.

An embodiment of this disclosure further provides a computer-readable storage medium, where a computer program is stored in the computer-readable storage medium. When the computer program is executed by a processor, a plurality of processes of the configuration method in the foregoing embodiments are implemented, with the same technical effects achieved. To avoid repetition, details are not described again herein. The computer-readable storage medium includes a read-only memory (ROM), a random access memory (RAM), a magnetic disk, an optical disc, or the like.

It should be noted that the terms “comprise”, “include”, or any of their variants in this specification are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element.

According to the description of the foregoing implementations, persons skilled in the art can clearly understand that the method in the foregoing embodiments may be implemented by software in addition to a necessary universal hardware platform or by hardware only. In most cases, the former is a preferred implementation. Based on such an understanding, the technical solutions of this application essentially or the part contributing to the prior art may be implemented in a form of a software product. The software product may be stored in a storage medium (for example, a ROM/RAM, a magnetic disk, or an optical disc), and includes several instructions for instructing a terminal device (which may be a mobile phone, a computer, a server, an air conditioner, a network device, or the like) to perform the method described in the plurality of embodiments of this application.

The foregoing describes the embodiments of this application with reference to the accompanying drawings. However, this application is not limited to the foregoing specific implementations. The foregoing specific implementations are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A configuration method, applied to a terminal device, wherein the method comprises:
performing a first target operation on a target object based on target configuration information, wherein
in a case that the target configuration information is configuration information for uplink congestion failure detection, the target object is used for uplink congestion failure detection; and/or
in a case that the target configuration information is configuration information for uplink congestion failure recovery, the target object is used for uplink congestion failure recovery.

2. The method according to claim 1, wherein the target object comprises at least one of the following: a target timer or a target counter, wherein
in a case that the target object comprises the target timer, the first target operation comprises at least one of the following: starting the target timer, restarting the target timer, or stopping the target timer; and/or
in a case that the target object comprises the target counter, the first target operation comprises at least one of the following: updating a threshold of the target counter, or resetting the target counter.

3. The method according to claim 2, wherein the performing a first target operation on a target object based on target configuration information comprises:
starting the target timer in a case that the target object is the target timer and that the target configuration information is configured for the first time; or
starting the target timer in a case that the target object is the target timer, that the target timer is not started, and that the target configuration information is reconfigured; or
restarting or stopping the target timer in a case that the target object is the target timer, that the target timer has been started, and that the target configuration information is reconfigured; or
updating a threshold of the target counter in a case that the target object is the target counter and that the target configuration information is configured for the first time; or
updating a threshold of the target counter in a case that the target object is the target counter and that the target configuration information is reconfigured; or
resetting the target counter in a case that the target object is the target counter and that the target configuration information is reconfigured.

4. The method according to claim 3, wherein in a case that the target object is used for uplink congestion failure detection, the target timer is a first timer, the target counter is a first counter, and a threshold of the first counter is an uplink congestion failure detection threshold.

5. The method according to claim 4, wherein in a case that the target timer is the first timer, the starting or restarting the first timer comprises:
starting or restarting the first timer in a case that the terminal device meets a first condition, wherein
the first condition comprises at least one of the following: an uplink signal is transmitted for the first time after the configuration information for uplink congestion failure detection is obtained; or an uplink signal transmission failure occurs for the first time after the configuration information for uplink congestion failure detection is obtained.

6. The method according to claim 3, wherein in a case that the target object is used for uplink congestion failure recovery, the target timer is a second timer, the target counter is a second counter, and a threshold of the second counter is an uplink congestion failure recovery threshold.

7. The method according to claim 6, wherein in a case that the target timer is the second timer, the starting or restarting the second timer comprises:
starting or restarting the second timer in a case that the terminal device meets a second condition, wherein
the second condition comprises at least one of the following: an uplink congestion failure occurs after the configuration information for uplink congestion failure recovery is obtained; a frequency carrying an uplink signal is activated or changed to another frequency after the configuration information for uplink congestion failure recovery is obtained; a secondary cell of the terminal device for uplink congestion failure recovery is activated after the configuration information for uplink congestion failure recovery is obtained; or a secondary cell of the terminal device for uplink congestion failure recovery is added after the configuration information for uplink congestion failure recovery is obtained.

8. The method according to claim 6, wherein the stopping the second timer comprises:
stopping the second timer in a case that the terminal device meets a third condition, wherein
the third condition comprises at least one of the following: a frequency carrying an uplink signal is deactivated or changed to another frequency after the configuration information for uplink congestion failure recovery is obtained; a secondary cell of the terminal device for uplink congestion failure recovery is deactivated after the configuration information for uplink congestion failure recovery is obtained; or a secondary cell of the terminal device for uplink congestion failure recovery is removed after the configuration information for uplink congestion failure recovery is obtained.

9. The method according to claim 6, wherein the method further comprises:
determining, by using the target object, whether uplink congestion failure recovery is successful in a cell of the terminal device for uplink congestion failure recovery.

10. The method according to claim 9, wherein the determining, by using the target object, whether uplink congestion failure recovery is successful in a cell of the terminal device for uplink congestion failure recovery comprises:
in a case that the target object comprises the second counter, if a count value of the second counter is greater than or equal to the uplink congestion failure recovery threshold, determining that the uplink congestion failure recovery has failed in the cell of the terminal device for uplink congestion failure recovery; and
in a case that the target object comprises the second counter and the second timer, within duration of the second timer, if a count value of the second counter is greater than or equal to the uplink congestion failure recovery threshold, determining that the uplink congestion failure recovery has failed in the cell of the terminal device for uplink congestion failure recovery.

11. The method according to claim 10, wherein after the determining, by using the target object, whether uplink congestion failure recovery is successful in a cell of the terminal device for uplink congestion failure recovery, the method further comprises:
performing a second target operation in a case that it is determined, by using the target object, that the uplink congestion failure recovery has failed in the cell of the terminal device for uplink congestion failure recovery, wherein
the second target operation comprises at least one of the following: a first operation or a second operation;
the first operation is to trigger a wireless connection re-establishment procedure; and
the second operation is to transmit failure information to a network device, wherein the failure information is used to indicate that the uplink congestion failure recovery has failed in the cell of the terminal device for uplink congestion failure recovery.

12. The method according to claim 11, wherein
in a case that the uplink congestion failure recovery has failed in a primary cell of the terminal device, the second target operation comprises at least one of the following: the first operation or the second operation; or
in a case that the uplink congestion failure recovery has failed in all cells in a master cell group of the terminal device, the second target operation comprises at least one of the following: the first operation or the second operation; or
in a case that the uplink congestion failure recovery has failed in all cells in a secondary cell group of the terminal device, the second target operation is the second operation; or
in a case that the uplink congestion failure recovery has failed in a primary secondary cell of the terminal device, the second target operation is the second operation; or
in a case that the uplink congestion failure recovery has failed in a secondary cell of the terminal device, the second target operation is the second operation.

13. A terminal device, comprising a processor, a memory, and a computer program stored in the memory and capable of running on the processor, wherein the computer program is executed by the processor to implement:
performing a first target operation on a target object based on target configuration information, wherein
in a case that the target configuration information is configuration information for uplink congestion failure detection, the target object is used for uplink congestion failure detection; and/or in a case that the target configuration information is configuration information for uplink congestion failure recovery, the target object is used for uplink congestion failure recovery.

14. The terminal device according to claim 13, wherein the target object comprises at least one of the following: a target timer or a target counter, wherein
in a case that the target object comprises the target timer, the first target operation comprises at least one of the following: starting the target timer, restarting the target timer, or stopping the target timer; and/or
in a case that the target object comprises the target counter, the first target operation comprises at least one of the following: updating a threshold of the target counter, or resetting the target counter.

15. The terminal device according to claim 14, wherein the computer program is executed by the processor to implement:
starting the target timer in a case that the target object is the target timer and that the target configuration information is configured for the first time; or
starting the target timer in a case that the target object is the target timer, that the target timer is not started, and that the target configuration information is reconfigured; or
restarting or stopping the target timer in a case that the target object is the target timer, that the target timer has been started, and that the target configuration information is reconfigured; or
updating a threshold of the target counter in a case that the target object is the target counter and that the target configuration information is configured for the first time; or
updating a threshold of the target counter in a case that the target object is the target counter and that the target configuration information is reconfigured; or
resetting the target counter in a case that the target object is the target counter and that the target configuration information is reconfigured.

16. The terminal device according to claim 15, wherein in a case that the target object is used for uplink congestion failure detection, the target timer is a first timer, the target counter is a first counter, and a threshold of the first counter is an uplink congestion failure detection threshold.

17. The terminal device according to claim 16, wherein in a case that the target timer is the first timer, the computer program is executed by the processor to implement:
starting or restarting the first timer in a case that the terminal device meets a first condition, wherein
the first condition comprises at least one of the following: an uplink signal is transmitted for the first time after the configuration information for uplink congestion failure detection is obtained; or an uplink signal transmission failure occurs for the first time after the configuration information for uplink congestion failure detection is obtained.

18. The terminal device according to claim 15, wherein in a case that the target object is used for uplink congestion failure recovery, the target timer is a second timer, the target counter is a second counter, and a threshold of the second counter is an uplink congestion failure recovery threshold.

19. The terminal device according to claim 18, wherein in a case that the target timer is the second timer, the computer program is executed by the processor to implement:
starting or restarting the second timer in a case that the terminal device meets a second condition, wherein
the second condition comprises at least one of the following: an uplink congestion failure occurs after the configuration information for uplink congestion failure recovery is obtained; a frequency carrying an uplink signal is activated or changed to another frequency after the configuration information for uplink congestion failure recovery is obtained; a secondary cell of the terminal device for uplink congestion failure recovery is activated after the configuration information for uplink congestion failure recovery is obtained; or a secondary cell of the terminal device for uplink congestion failure recovery is added after the configuration information for uplink congestion failure recovery is obtained;
or,
stopping the second timer in a case that the terminal device meets a third condition, wherein
the third condition comprises at least one of the following: a frequency carrying an uplink signal is deactivated or changed to another frequency after the configuration information for uplink congestion failure recovery is obtained; a secondary cell of the terminal device for uplink congestion failure recovery is deactivated after the configuration information for uplink congestion failure recovery is obtained; or a secondary cell of the terminal device for uplink congestion failure recovery is removed after the configuration information for uplink congestion failure recovery is obtained.

20. A computer-readable storage medium, wherein the computer-readable storage medium stores a computer program, and the computer program is executed by a processor to implement:
performing a first target operation on a target object based on target configuration information, wherein
in a case that the target configuration information is configuration information for uplink congestion failure detection, the target object is used for uplink congestion failure detection; and/or
in a case that the target configuration information is configuration information for uplink congestion failure recovery, the target object is used for uplink congestion failure recovery.
